(19) United States
(12) Patent Application Publication
(10) Pub. No.: US 2006/0035054 A1
(43) Pub. Date: Feb. 16, 2006

(54) High performance vacuum-sealed insulations

(75) Inventors: Christopher J. Stepanian, Somerville, MA (US); Roxana Trifu, Shrewsbury, MA (US); Duan Li Ou, Framingham, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aspen Aerogels, Inc., Northborough, MA (US)

(21) Appl. No.: 11/219,084

(22) Filed: Sep. 1, 2005

Related U.S. Application Data
(63) Continuation-in-part of application No. 11/030,014, filed on Jan. 5, 2005.
(60) Provisional application No. 60/606,400, filed on Sep. 1, 2004.
(60) Provisional application No. 60/534,084, filed on Jan. 5, 2004.

(51) Int. Cl. B32B 1/04

(52) U.S. Cl. 428/76

(57) ABSTRACT

An insulating structure comprising an aerogel composite fully enclosed by an envelope and sealed at a reduced pressure, said aerogel composite comprising at least one metal oxide matrix and a fibrous material incorporated therein, and where said insulating structure can bend to at least 90° and a bending radius of less than ½ inch without any substantial fracture.

### CROSS-REFERENCES TO RELATED APPLICATIONS

This application claims benefit of priority from U.S. Provisional Patent Application 60/606,400, filed Sep. 1, 2004. This application is also a continuation-in-part of U.S. patent application Ser. No. 11/030,014, filed Jan. 5, 2005, which claims benefit of priority to U.S. Provisional Patent Application 60/534,084, filed Jan. 6, 2004. All three applications are hereby incorporated by reference in their entireties as if fully set forth.

### STATEMENT REGARDING FEDERALLY SPONSORED RESEARCH OR DEVELOPMENT

This invention was partially made with Government support under Contract NAS09-03022 (an SBIR Grant) awarded by the National Aeronautics and Space Administration (NASA) and under Contract W81XWH-04-C-0046 with the United States Army. The Government has certain rights in parts of this invention.

### FIELD OF THE INVENTION

This invention relates to an aerogel composite that is enveloped by a material that allows the aerogel composite to be maintained under a partial vacuum. Stated differently, the aerogel composite is fully enclosed or encased by an envelope sealed at a reduced pressure. The aerogel composite is flexible, and the products of the invention may be advantageously used as insulating materials. The invention further provides products containing the enveloped aerogels of the invention as well as methods of preparing and using the enveloped aerogels.

### BACKGROUND OF THE INVENTION

Insulation materials employed for certain applications must meet a variety of performance capabilities to merit consideration. For instance, cold volume enclosures such as cryogenic insulation for space vehicles may require flexibility, high thermal resistance, lightweight, and mechanical stability as bare minimum prerequisites.

Aerogels describe a class of materials based upon their structure, namely low density, highly porosity, open-cell structures and large surface areas. Such materials may be prepared by polymerization of organic, inorganic or hybrid copolymerized organic-inorganic compounds resulting in solvent-filled nanoporous 3-D structures (i.e “wet gel”.) The resulting wet gel can be dried to remove the solvents from the pores resulting in the aerogel structure. The Sol gel method of preparing porous wet gels in combination with supercritical drying thereof is one method of preparing aerogels. This method is further described in Sol-Gel Science by Brinker and Scherer, academic press 1990.

Methods of drying gels for generating aerogels or xerogels are known in the field. Kistler (J. Phys. Chem., 36, 1932, 52-64) describes a drying process where the gel solvent is maintained above its critical pressure and temperature. Due to the absence of any capillary forces, such supercritical drying maintains the structural integrity of the gel. U.S. Pat. No. 4,610,863 describes a process where the gel solvent is exchanged with liquid carbon dioxide and subsequently dried at conditions where carbon dioxide is in a supercritical state. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels.

U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising drying a wet gel comprising gel solids and a drying agent to remove the drying agent under drying conditions sufficient to minimize shrinkage of the gel during drying.

Also, U.S. Pat. No. 5,420,168 describes a process whereby Resorcinol/Formaldehyde aerogels can be manufactured using a air drying procedure. U.S. Pat. No. 5,565,142 describes a process where the gel surface is modified such that it is more hydrophobic and stronger so that it can resist any collapse of the structure during ambient or subcritical drying. Surface modified gels are dried at ambient pressures or at pressures below the critical point (subcritical drying). Products obtained from such ambient pressure or subcritical drying are often referred to as xerogels.

Citation of documents herein is not intended as an admission that any is pertinent prior art. All statements as to the date or representation as to the contents of documents is based on the information available to the applicant and does not constitute any admission as to the correctness of the dates or contents of the documents.

### DESCRIPTION AND MODES OF PRACTICING THE INVENTION

This invention relates to an aerogel composite sealed in a envelope at reduced pressure or partial vacuum. Such structures and articles of manufacture of the invention may be advantageously used as insulation or insulation products, including as a cold volume enclosure in whole or in part. Such uses include that of being a passive insulation body to maintain either a constant temperature or a significant delta temperature between an object and its surroundings. The structures and articles of manufacture include those that are flexible, lightweight, and have high thermal resistance and mechanical stability as characteristics, making them suitable as cryogenic insulation in applications such as in space vehicles. The flexibility of the structures and articles also advantageously permit use in applications requiring conformity to the shape of a final structure.

In one aspect, the invention provides a structure comprising an aerogel composite fully enclosed or encased in an envelope and sealed at a reduced pressure or a partial vacuum. The structure may be used as an insulating material in some embodiments. The structure may also be considered as a sealed envelope forming, or defining, a volume under reduced pressure or a partial vacuum, and including an aerogel composite as described herein within the volume. In some embodiments, the aerogel composite is an aerogel matrix comprising at least one fibrous material incorporated therein. In additional embodiments, the aerogel matrix comprises a metal oxide, an organic polymer or a combination of both (organic-inorganic hybrid.).

Thus in another aspect, the invention provides an enveloped or encased aerogel composite wherein the composite comprises a fibrous material incorporated therein and at least one metal oxide. In some embodiments, the composite, or the enveloped composite, is capable of bending to at least 90° and/or have a bending radius of less than ½ inch. Embodiments include those wherein the composite does not exhibit any substantial fracture under such conditions. A substantial fracture is one that is visually detectable by the unaided eye.

An aerogel composite refers to a solid material comprising aerogel material and at least one substance that introduces flexibility into the aerogel material to make it more flexible than in the absence of the material. The composite thus retains properties of the aerogel material and the properties of the flexibility introducing substance, respectively. The respective properties of the aerogel material and the flexible substance contributes to the desirable properties of a flexible aerogel. The aerogel material, flexibility introducing substance, and any other material that may be present in the composite are combined at least on a macroscopic scale. The solid composite is in the form of a continuous matrix or unitary material or a “monolithic” material as opposed to particles or beads.

FIGS. 1-4 are photographs depicting non-limiting examples of flexible aerogel composites that may be used in the practice of the invention. In all of these examples, no visible fractures were detectable by the unaided human eye.

The articles and structures of the invention are based in part on the discovery that flexible aerogel composites retain their characteristics when enveloped by another material under reduced pressure conditions. Even under conditions of compression by the envelope due to the reduced pressure, or partial vacuum, the aerogel composites were not observed to negative impacts like loss of flexibility and insulating properties due to compression-mediated deformation. As noted in greater detail below, the aerogel composites of the invention are capable of retaining their flexibility and insulating properties under the reduced pressure/partial vacuum conditions of the invention. Thus the compression of aerogel composites, expected to reduce thickness and/or increase stiffness, was discovered to be of acceptable levels for retaining desirable properties in the composite.

The articles and structures of the invention may be in a variety of shapes and sizes. In some embodiments, the shapes and sizes are dictated by the shape and size of the aerogel composite. Thus the encasing of planar or non-planar aerogel composites would result in the preparation of planar or non-planar, respectively, structures and articles of the invention. In some embodiments, the aerogel may be a three dimensional shape, optionally defining an opening or volume. In other embodiments, the articles and structures are curved such that they may be placed like blankets upon and around pipes, pipelines or other cylindrical or generally cylindrical objects. The articles and structures may be in the form of overlapping blankets which act together to insulate a pipe, pipeline, or other cylindrical object. In some embodiments, the pipe or pipeline is one which contains or transports liquefied natural gas (LNG) or other hydrocarbon or hydrogen based fuel.

The term aerogel describes a class of structures rather than a specific material. A variety of different aerogel compositions are possible such as the inorganic, organic and organic-inorganic hybrid variety. Inorganic aerogels are generally based upon metal oxide compounds independently selected from, but not limited to, silica, titania, zirconia, alumina, hafnia, yttria, ceria or combinations thereof. An aerogel composite may also comprise various carbides, nitrides or any combination thereof. Of course combinations of metal oxides and a nitride or carbide (or both) may also be used in the practice of the invention. Organic aerogels can be based on compounds selected from, but not limited to, urethanes, resorcinol formaldehydes, polyimide, polyacrylates, chitosan, polymethyl methacrylate, a member of the acrylate family of oligomers, trialkoxysilylterminated polydimethylsiloxane, polyoxyalkylene, polyurethane, polybutadiane, a member of the polyether family of materials, or combinations thereof. Non-limiting examples of organic-inorganic hybrid aerogels include, but not limited to, silica-PMMA, silica-chitosan or a combination of the aforementioned organic and inorganic compounds.

The invention may be practiced with a fiber-reinforced aerogel composites, which may optionally be in “blanket” form such that they are sufficiently flexible to have the characteristics of being drape-able and/or blanket-like. The may also be defined by the ability to be rolled up for storage without significant deformation, such as, but not limited to, cracking or breaking. Flexible also refers to the extent to which an aerogel composite being able to bend without introduction of fractures visible to the unaided eye. Fiber-reinforced aerogel composites (blankets) can take on a variety of forms. The fibrous material in the fiber-reinforced composite aerogels presently described can be in forms such as batting (fibrous or lofty), fibrous mats, felts, microfibers or a combination thereof. Additional details of other non-limiting fiber-reinforced aerogel composites are provided below. Moreover, fiber reinforced forms of organic, inorganic and hybrid organic-inorganic aerogles can also be prepared and used in the practice of the invention. Fiber-reinforced hybrid organic-inorganic aerogels composites that are also highly flexible are further described below. The fibrous material is optionally coated with a polymeric or metallic compound.

In some embodiments, the aerogel composites are prepared via incorporating a lofty batting within an aerogel. The composite is subsequently sealed at reduced pressures, or partial vacuum, in the practice of the invention. In many embodiments, the reduced pressure is that which is less than that of earth's atmosphere at sea level. A lofty batting and on its use for preparing aerogel composites is further discussed below.

Aerogel composites of the invention may have densities between about 0.01 and about 0.40 g/cc, or between about 0.07 to about 0.30 g/cc. Of course composites with densities of about 0.02, about 0.03, about 0.04, about 0.05, about 0.06, about 0.07, about 0.08, about 0.09, about 0.10, about 0.12, about 0.14, about 0.16, about 0.18, about 0.20, about 0.22, about 0.24, about 0.26, about 0.28, about 0.30, about 0.32, about 0.34, about 0.36, or about 0.38 g/cc may also be used. As would be understood by the skilled person, the density of an aerogel has an effect on the flexibility thereof. As a general approximation, increases in density are accompanied by a decrease in flexibility. But of course flexibility can be retained or increased in an aerogel by incorporation of materials as described herein.

To improve the thermal insulation performance of an aerogel composite, an IR opacifying agent may be added to the composite matrix prior to gelation thereof. Suitable opacifying agents for the purposes of the present embodiments include, but are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

An aerogel composite of the invention may be formed into a structure by sealing the aerogel composite in a envelope at reduced pressures such as between about 760 torr and about 10⁻⁶ torr, or between about 760 torr and about 1 or about 0.2 torr, or between about 1 to about 10 torr. Thus the invention also provides a method of preparing an enveloped aerogel composite as provided herein comprising sealing the composite in an envelope under reduced pressure conditions as described above. Envelopes of the invention may also be referred to as vacuum films or barrier films in some embodiments of the invention.

The gas, if any, remaining under reduced pressure in the envelope may be that of the earth's atmosphere or a gas that was introduced into the envelope before evacuation of gas to form a partial vacuum or reduced pressure. Non-limiting examples of gases for introduction (or a filler gas) include those with a low thermal conductivity, such as, but not limited to, argon, bromine, carbon disulfide, dichlorodifluoromethane, krypton, sulfur hexafluoride, and trichlorofluoromethane. In some embodiments of the invention, such as, but not limited to envelopes made of stiff or rigid materials, the introduced gas may be referred to as a charging gas that is removed by an absorbent within the sealed envelope to create a reduced pressure or partial vacuum. Such a structure may be referred to as a self-evacuating VIP. A non-limiting example of a charging gas is carbon dioxide, where carbon dioxide absorbents are known to the skilled person.

In some embodiments at pressures between about 760 torr and about 0.2 torr and the temperature is between about 20° C. and about −122° C., the thermal conductivity of the aerogel composite within a structure of the invention is between about 2.2 mW/mK and about 13.2 mW/mK. In other embodiments at pressures between about 760 torr and about 0.2 torr and the temperatures is between about 38° C. and about −130° C., the thermal conductivity of the aerogel composite within a structure of the invention is between about 2.85 mW/mK and about 12.7 mW/mK.

The envelope used in the practice of the invention may be any sealable material that can be used to form and maintain a volume at reduced pressures or under partial vacuum. In some embodiments, the envelope is a polymeric material that is substantially air-impermeable. As a non-limiting example, the material as an envelope is able to maintain reduced pressures (below atmospheric) for as long as 15-20 years, such as where there is no increase in pressure due to leakage from any envelope seam. In some embodiments, the polymeric material or film, optionally coated with a metallic substance, such as IR opacification, to improve thermal properties. In one non-limiting example, the envelope material is an aluminized polymeric film commercially sold under the name Mylar. In other embodiments, the invention may also be practiced with relatively hard or stiff materials as the envelope. In additional optional embodiments, the envelope material is not glass.

The bending radius of the structures of the invention may be less than about ½, or less than about ¼ or less than about ⅛ inch. FIGS. 5 and 6 demonstrate the flexibility of an aerogel composite as a vacuum insulated panel (VIP) of the invention, bent to more than 90°. FIG. 6 includes a measurement reference, demonstrating a radius of curvature less than ½ inch.

The thermal conductivity of the structures of the invention, given reduced pressures, may range between about 2 mW/mK and about 18 mW/mK or between about 4 mW/mK and about 18 mW/mK. This may be compared to conductivities of between about 11 mW/mK and about 18 mW/mK at about atmospheric pressures for the aerogel composite alone.

In another aspect, a structure or article containing more than one layer of composite aerogels are present within a vacuum-sealed envelope. Thus more than one ply of aerogel composite may be used in the practice of the invention. The insulating characteristics, or resistance to heat flow, of the overall structure can be improved in such embodiments. The more than one layer of aerogel composites may be of the same or different types of aerogels.

For insulating materials, resistance to heat flow (R) is typically measured as an R-value with each insulation ply (in a multi-ply structure) exhibiting a particular R/inch of thickness value. As such, reduction in insulation thickness in each ply, due to compression, can significantly reduce the overall R-value. Adjustment of the target density is one way of controlling compression resistance, while incorporation of a molecular reinforcement component, such as organic polymers within an inorganic network is another. The insulating structures described herein may be optimized to possess low density, high compressive strength, high flexibility and low thermal conductivity characteristics. With respect to flexural strength, aerogel composites of the invention have strengths of at least about 100 psi at rupture.

In a further aspect, the invention provides a structure or article containing at least one layer of a composite aerogel and at least one layer of fibrous or non-fibrous material which are co-sealed at reduced pressures in an envelope. The R-value of the overall structure may be raised with this approach. As non-limiting examples, the fibrous material may be a polyester batting, quartz silica batting, carbon felt or a combination thereof.

In the practice of the invention, the enveloped aerogel composite structure may be bent or otherwise shaped to a desired conformation prior to reduction of pressure within the envelope. In some embodiments, the envelope is sufficiently flexible to participate in the retention of the aerogel composite's shape or conformation. Thus the envelope may be sufficiently flexible to conform to the shape or conformation of the composite. Alternatively, the envelope material may be relatively inflexible or rigid but shaped to participate in maintaining the composite's shape or conformation.

The desired shapes or conformations can include bi-planer bending angles of less than about 90°, less than about 80°, less than about 70°, less than about 60°, less than about 50°, less than about 40°, less than about 30°, less than about 20°, or less than about 10°. The radii of curvature in such bent shape may be of about ⅛ inch, about ¼ inch, about ½ inch, about 1 inch, about 2 inches, about 3 inches, about 4 inches, about 5 inches, about 6 inches, about 7 inches, about 8 inches, about 9 inches, or about 10 inches and above. See FIGS. 1-4 for demonstrations of bent aerogel composites that do not display any noticeable fracture.

Without being bound by theory, and offered to improve the understanding of the invention, it is believed that absence of visible (to the unaided eye) fractures upon bending indicates an absence of significant change in thermal conductivity characteristics of aerogel composites of the invention. This belief is based, but not limited by, the following. First, the solid conduction component of thermal conductivity is not significantly increased if no additional solid conduction pathways are created. Second, and while the air conduction component of thermal conductivity may increase if larger pores are created due to bending, this effect is negligible under the reduced pressures of the invention. Additionally, the radiative component of the thermal conductivity depends essentially on the total amount of solid (mass) present, which is unchanged even if fractures are created.

In yet another aspect, the invention provides a vacuum insulated panel (VIP) or vacuum insulated box (VIB) comprising an enveloped aerogel composite as provided herein. In the case of a VIP, the enveloped aerogel composite may be used as the VIP per se or used with other materials to form a VIP. As a non-limiting example, an enveloped structure of the invention may be placed within the wall of a box wherein the wall becomes the VIP. Alternatively, an enveloped structure of the invention is encased by another material to form a VIP.

The VIP may also be more generally referred to as a vacuum insulated structure (or VIS). In a further embodiment, a VIS may comprise an additional reinforcing material incorporated into, or external to, the aerogel composite. The reinforcing material may be used to provide structural support and/or to enhance conformity of the VIS to a shape or maintenance of a bend. The additional reinforcing component is able to flex at least at least as well as (e.g. to the same degree of flexure) as the aerogel composite and/or enveloping material of a VIS and remain in this flexed state to maintain the VIS in a desired conformation.

A variety of materials may be used as the reinforcing component based on their property of undergoing plastic deformation. Non-limiting examples of such materials include, but are not limited to, stainless steel, elemental metals such as copper or iron, and other metallic, semi-metallic and alloyed materials. Materials used as the reinforcing component may, of course be selected to be stable and/or not mechanically affected in the operating temperatures and environment of the VIS. Thus the reinforcing component would retain the capacity to hold a particular conformation under the VIS's operating conditions. The reinforcing component may also be selected to be chemically resistant to the species present in the operating environment of the VIS.

A variety of physical forms of a reinforcing component may be used because their mechanical properties can be exploited in various ways. Non-limiting examples include, but are not limited to, reinforcing components in the form of a mesh, a screen, and other common analogous forms such as “chicken-wire”. A reinforcing component may be cast into the aerogel material by placing them into the gel structure before complete formation (gelation) thereof. The resultant aerogel composite, containing the incorporated (or integrated) reinforcing material may be used in a VIS.

Alternatively, or in conjunction therewith, a reinforcing component may be present adjacent to, or otherwise within the enveloped volume containing an aerogel composite of the invention. Thus the reinforcing component may also be a layer, or an interlay, between aerogel composites within a VIS. As a further alternative, a reinforcing component may be adjacent to, or otherwise external to, the enveloped aerogel composite such that it reinforces from the exterior rather than from the interior volume at reduced pressure. In embodiments comprising a reinforcing component, the resultant VIS may be bent or otherwise deformed according to the desired final conformation of the VIS (insulating structure).

Such a reinforced VIS of the invention may be used in a variety of applications as described herein, including, but not limited to, the insulation of pipes and pipelines, including those containing or transporting liquefied natural gas or other hydrocarbon or hydrogen based fuels.

In the case of a VIB, an enveloped structure of the invention may form one or more sides of the VIB as a non-limiting example. Alternatively, an enveloped structure of the invention may be designed such that it can be used to constitute all or part of a VIB. One non-limiting embodiment of the present invention involves a technique to cut and assemble a VID, optionally with a minimal number of seams. The core material for the vacuum insulated structure may be an aerogel blanket with an organic, inorganic or organic-inorganic matrix as described herein. An aerogel blanket with a hybrid organic-inorganic matrix, as a non-limiting example, is one suitable form for the present embodiments, though same or similar properties may be achived using inorganic (e.g. silica) or organic based aerogel blankets. Such blankets can be very stiff resulting in minimized thickness and thermal resistance loss when the core is compressed at one atmosphere pressure in the VIB.

The thermal resistance of an insulating material is typically increased when sealed under reduced (vacuum) pressures. With this increase in thermal resistance, heat flux paths that were once insignificant compared to the faces of a VIB can become significant. Heat flux through the interface between vacuum insulated panels (VIPs) and between the cover and the box become significant once the overall flux through the box walls drops. A design approach to minimize the number of seams in such structures can have a significant impact on the thermal performance of the enclosure.

The minimally seamed approach to manufacturing a VIB consists of a pattern and technique for making the VIB core along with a film encapsulation and evacuation method suitable for fabricating the structure. This minimally seamed approach eliminates the standard method of more than one VIP butted together to form a VIB. VIBs can derive additional thermal performance by exploiting an aerogel composite's ability to perform at much lower thermal conductivities at reduced pressures. Such reduced pressures can be between about 10⁻⁶ torr and about 760 torr or between about 10⁻² torr and about 760 torr. Reduced pressures between about 760 torr and about 1 torr or between about 1 and about 10 torr may also be used. The resulting VIB design can be a significant improvement over existing approaches to manufacture vacuum insulated box-type structures.

The manufacturing process for the VIB may consist of three parts: core manufacture, bagging, and evacuation. The composite aerogel can be developed to exhibit enough flexiblity to conform to the curvature in box edges (excluding corners) with approximately 90° angles and/or radius of curvature greater than about ⅛ inches without any observable fracture. In one embodiment, the aerogel blanket core resembles a cross with an option for attachment tabs where upon folding, results in a five sided box with a living hinge cover. This as well as other configurations are illustrated in FIG. 11.

The tabs in FIG. 11 (as shown in parts B, C and D) serve to eliminate any heat leak paths and may be used to anchor the core structure together to form the box. Once the box is formed, the vacuum bag film (envelope) should closely conform to the shape of the final part. This ensures that the VIB's film is without wrinkles. Bag wrinkling may result if a non-gussetted or non-seamed vacuum bag structure is used.

The five-sided box design in part D of FIG. 11 may be used to prepare a first and second five-sided shape wherein the first can fit over the opening of the second and so serve as the “top” or “cover” for the second. Stated differently, the first and second may be related in the manner of a tight fitting conventional shoe box, where the cover of the shoebox is a five-sided shape that fits over the five-sided base of the shoe box. The sizes of the first and second shapes may be designed to provide a minimal gap between the two to maximally insulate the internal volume.

In another embodiment, such a cover and bottom box design may comprise a thermally conductive layer. The cover and bottom box may be optionally prepared by use of the five-sided box design in part D of FIG. 11. The thermally conductive layer may be any as described below. A non-limiting illustration of this aspect of the invention is provided in FIG. 12, which shows a VIB cross-section with cover 10 and a body (box) 11. The VIB comprises a thermally conductive layer 12 which is capable of conducting heat flux 13 going into the box. The space between cover 10 and body 11 may allow cold gas 14 to exit the interior of the box. FIG. 13 is an illustration of a portion (upper left quadrant) of the VIB cross-section of FIG. 12. In the figure, cold gas 23 about to leave the gap between cover 20 and body 21 is shown as becoming cool gas 24 (with heat added from the thermally conductive layer 22) which leaves via the gap.

In a further embodiment, an approach for minimizing wrinkles is provided. The approach includes constructing two, five sided bags that may be placed on the inside and the outside of the aerogel core (see FIG. 14). These bags would be seamed together at the top, such as by using COTS film seaming technology as a non-limiting example. Vacuum would be applied using a vacuum pump and a one-way valve. The applied vacuum can be applied to achieve reduced pressures of between about 10⁻⁶ torr and about 760 torr or between about 10⁻² torr and about 760 torr. Reduced pressures of between about 1 and about 760 torr or between about 1 and about 10 torr may also be used.

The outlined approach in FIG. 14 results in a nearly seamless (3 seams vs. 12 seams) VIB. The nearly seamless approach to the VIB practically eliminates a major source of heat fiux through the seams of the box. The longevity of the vacuum insulated box is also expected to be high based upon its ability to perform at soft vacuum levels. A VIB pulled to hard vacuum levels will maintain thermal performance for a longer time based upon a known leak rate of gas into the enclosure compared to other core materials such as Instill foam. Of course the invention further provides for the use of a first and a second of such nearly seamless VIBs wherein the first fits over the second other such that the first is the top for the second, such as in the manner of a tight fitting conventional shoe box as described above. Again, the sizes of the first and second shapes may be designed to provide a minimal gap between the two to maximally insulate the internal volume.

The described VIBs may be applied to rectangular refrigerator/freezer enclosure technologies such as refrigerated transportation (via truck, train, etc.), household refrigerators and cryogenic dewar insulators for hospitals. Similarly, such VIBs may act to keep internal items warm, such as is the case for bread proofing ovens or pizza delivery bags.

In a yet additional embodiment, a flexible aerogel blanket such as those described herein is manipulated to conform to a variety of surfaces. As a non-limiting example, a blanket enclosed by an envelope could be made to conform to a surface to be insulated where the envelope is then evacuated after said blanket has engaged a surface to result in a conforming insulated enclosure. This enclosure could either be sealed subsequent to evacuation or could be continuously pumped to ensure optimal thermal performance.

In another embodiment the aerogel blanket is pre-compressed at 50 psi to 2000 psi and placed between the inner and outer walls of a metallic box-in-box unit. The insulation space is placed under reduced pressures of between about 10⁻⁶ torr and about 760 torr or between about 10⁻² torr and about 760 torr. Reduced pressures of between about 1 and about 760 torr or between about 1 and about 10 torr may also be used. Examples of applications herein include cryogenic science-sample freezers for the International Space Station (ISS), or other applications in space, to maintain low temperatures, such as about −193° C.

In a further embodiment, bags (envelope) were formed out of Phase Change Material (PCM). Aerogel sheets using adhesive are used to seal the joints (see FIG. 15 for an inner pouch design). A 6″×4″ sealed plastic bag filled with 200 ml water is inserted in the bag and replicates the PRBC. Multiple layers of PCM aerogels have been tested under vacuum for thermal performance.

In another aspect, the invention provides for placing a conductive layer place within an aerogel composite VIB or VIP such that the heat flux across the structure is reduced. Said conductive layer may be in the form of a metallic sheet and be placed between two aerogel composites where the temperature escaping the structure is in contact with the conductive layer.

Fiber Reinforced Aerogel Composite Blanket

An aerogel blanket comprising a fibrous material may be prepared used in the practice of the invention. Such a composite may be considered to have two parts, namely reinforcing fibers and an aerogel matrix. In some embodiments, the reinforcing fibers are in the form of a lofty fibrous structure (e.g. batting), such as those based upon either thermoplastic polyester or silica fibers, optionally in combination with individual randomly distributed short fibers (microfibers). The use of a lofty batting reinforcement may act to minimize the volume of unsupported aerogel while generally improving the thermal performance of the aerogel. Moreover, when an aerogel matrix is reinforced by a lofty batting material, such as a continuous non-woven batting comprised of very low denier fibers, the resulting composite material at least maintains the thermal properties of a monolithic aerogel in highly flexible, drape-able form. An aerogel reinforced by the combination of the lofty fibrous batting and microfibers may also exhibit a delay by one or more orders of magnitude (e.g. increasing burn through from seconds to hours), the rate of shrinkage, sintering, and ultimate failure of the aerogel as an insulation structure.

The lofty fibrous material may be a combination of the lofty batting and one or more fibrous materials of significantly different thickness, length, and/or aspect ratio. One combination of a two fibrous material system is produced when a short, high aspect ratio microfiber (one fibrous material) dispersed throughout an aerogel matrix that penetrates a continuous lofty fiber batting (the second fibrous material).

The aerogel matrix may be organic, inorganic, or a mixture thereof. The wet gels used to prepare the aerogels may be prepared by any of the gel-forming techniques that are known to the skilled person. Non-limiting examples include adjusting the pH and/or temperature of a dilute metal oxide sol to a point where gelation occurs. Suitable metal oxide materials for forming inorganic aerogels include oxides of metals such as silicon, aluminum, titanium, zirconium, hafnium, yttrium, vanadium, and the like. Gels formed primarily from alcohol solutions of hydrolyzed silicate esters (alcogel) due to their ready availability and low cost may be used.

Generally, and to illustrate the preparation of an aerogel, a gel precursor is added to a reinforcing batting in some constraining mold type structure. A gel precursor may be mixed with microfiber material being cast into a continuous lofty fiber batting material to generate a non-limiting composite. For example, the principal synthetic route for the formation of an inorganic aerogel is the hydrolysis and condensation of an appropriate metal alkoxide. Suitable materials for use in forming an aerogel to be used at low temperatures are the non-refractory metal alkoxides based on oxide-forming metals.

Alternatively, alternative methods can be utilized to make an aerogel composite. For example, a water soluble, basic metal oxide precursor can be gelled by acidification in water to make a hydrogel. Sodium silicate has been widely used for this purpose. Salt by-products may be removed from the silicic acid precursor by ion-exchange and/or by washing subsequently formed gels with water. Removing the water from the pores of the gel can be performed via exchange with a polar organic solvent such as ethanol, methanol, or acetone. The resulting dried aerogel has a structure similar to that directly formed by supercritical extraction of gels made in the same organic solvent. Another alternative method entails reducing the damaging capillary pressure forces at the solvent/pore interface by chemical modification of the matrix materials in their wet gel state via conversion of surface hydroxyl groups to tri-methylsilylethers to allow for drying of the aerogel materials at temperatures and pressures below the critical point of the solvent.

A lofty batting is a fibrous material that shows the properties of bulk and some resilience (with or without full bulk recovery). The preferred form is a soft web of this material. The use of a lofty batting reinforcement material minimizes the volume of unsupported aerogel while avoiding substantial degradation of the thermal performance of the aerogel. Batting preferably refers to layers or sheets of a fibrous material, commonly used for lining quilts or for stuffing or packaging or as a blanket of thermal insulation.

The reinforcing fibrous material in a composite is one or more layers of a lofty fibrous batting. While generally a “batting” is a product resulting from carding or Garnetting fiber to form a soft web of fiber in sheet form, for purposes of this invention “batting” also includes webs in non-sheet form provided that they are sufficiently open to be “lofty.” Batting commonly refers to a fibrous material commonly used for lining quilts or for stuffing or packaging or as a blanket of thermal insulation. Suitable fibers for producing the batting are relatively fine, generally having deniers of about 15 and below or about 10 and below. The softness of the web is a byproduct of the relatively fine, multi-directionally oriented fibers that are used to make the fiber web.

A batting is “lofty” if it contains sufficiently few individual filaments (or fibers) that it does not significantly alter the thermal properties of the reinforced composite as compared to a non-reinforced aerogel body of the same material. Generally this will mean that upon looking at a cross-section of a final aerogel composite, the cross-sectional area of the fibers is less than about 10%, less than about 8%, or less than about 5% of the total surface area of that cross section. The lofty batting may have a thermal conductivity of 50 mW/m-K, or less at room temperature and pressure to facilitate the formation of low thermal conductivity aerogel composites.

Another way of determining if a batting is sufficiently lofty is to evaluate its compressibility and resilience. A lofty batting is one that (i) is compressible by at least about 50%, at least about 65%, or at least about 80% of its natural thickness, and (ii) is sufficiently resilient that after compression for a few seconds it will return to at least about 70%, at least about 75%, or at least about 80% of its original thickness. Thus a lofty batting is one that can be compressed to remove the air (bulk) yet spring back to substantially its original size and shape. For example a batting may be compressed from its original 1.5″ thickness to a minimum of about 0.2″ and spring back to its original thickness once the load is removed. This batting can be considered to contain 1.3″ of air (bulk) and 0.2″ of fiber. It is compressible by 87% and returns to essentially 100% of its original thickness. Fiberglass batting used for home insulation may be compressed to a similar extent and springs back to about 80% of its original thickness, but does that quite slowly.

The batting described herein is substantially different from a fibrous mat, which is “a densely woven or thickly tangled mass,” i.e. dense and relatively stiff fibrous structures with minimal open space between adjacent fibers, if any. A lofty batting herein has a low density, e.g. in the range of about 0.1 to about 16 lbs/ft³ (0.001-0.26 g/cc) or about 2.4 to 6.1 lbs/ft³ (0.04 to 0.1 g/cc). Generally, mats are compressible by less than about 20% and show little to no resilience. A batting may retain at least 50% of its thickness after the gel forming liquid is poured in.

While a composite produced with a lofty batting is flexible, durable, has a low thermal conductivity and has a good resistance to sintering, the performance of the aerogel composite may be substantially enhanced by incorporating randomly distributer microfibers into the composite, particularly microfibers that will help resist sintering while increasing durability and decreasing dusting. The microfibers are incorporated into the composite by dispersing them in the gel precursor liquid and then using that liquid to infiltrate the lofty batting. Suitable microfibers typically range from about 0.1 to 100 μm in diameter, have high aspect ratios (L/d>5, preferably L/d>100), and are relatively uniformly distributed throughout the composite. Since higher aspect ratios improve composite performance, the longest microfibers possible are desired. But the microfibers should be short enough to minimize filtration by the lofty batting and long enough to have the maximum possible effect on the thermal and mechanical performance of the resulting composite. The microfibers may have a thermal conductivity of 200 mW/m-K or less to facilitate the formation of low thermal conductivity aerogel composites.

Suitable fibrous materials for forming both the lofty batting and the microfibers include any fiber-forming material, including, but not limited to, fiberglass, quartz, polyester (PET), polyethylene, polypropylene, polybenzimidazole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE), novoloid resins (Kynol), polyacrylonitrile (PAN), PAN/carbon, and carbon fibers. While the same fibrous material may be used in both the batting and the microfibers, a combination of different materials may be utilized.

The aerogel composite may also include a thermally conductive layer. As non-limiting examples, carbon fiber cloth or two orthogonal plies of unidirectional carbon fiber placed at the center of a composite provides a thermal breakthrough barrier under a high heat load, a high degree of IR opacification, and a thermally dissipative layer structure that will spread the heat out in the x-y plane of the composite. The thermally conductive layer in the middle, through the thickness, of the aerogel composite may be selected to have a minimal effect on the stiffness of the composite. Moreover, and it desired, the layer can have malleability or intrinsic conformability so that the resulting aerogel composite will be conformable, e.g. a copper wire mesh placed at the interlayer of the aerogel composite article confers conformability and deformability when the composite is bent. In addition, the conductive mesh also provides RFI and EMI resistance. When a metal mesh is used as one or more of the central layers, it also offers the benefit of producing an aerogel composite materia which is not only drapeable or flexible, but is also conformable, i.e. it can retain its shape after bending.

Silica Aerogel Blanket

In some embodiments, an aerogel blanket comprising a fibrous material and an inorganic aerogel matrix is prepared. The aerogel matrix may be based on an oxide compound independently selected from, but not limited to, silica, titania, zirconia, alumina, hafnia, yttria, or independently based on various carbides, nitrides, or any combination of the preceding. The fibrous material may be polyester, quartz silica or carbon fiber based. Of course a combination of fibrous materials may also be used. The aerogel composite is then placed in a envelope and evacuated to reduced pressures between about 760 torr and about 10⁻⁶ torr. Reduced pressures between about 760 torr and about 1 torr or between about 1 and about 10 torr may also be used.

Silica/PMA Blanket

In other embodiments, an aerogel composite comprising an organic-inorganic hybrid aerogel matrix and a fibrous material incorporated therein is prepared, placed in an envelope and brought to reduced pressures between about 760 torr and about 10⁻⁶ torr. Reduced pressures between about 760 torr and about 1 torr or between about 1 and about 10 torr may also be used. The inorganic phase of the aerogel matrix may be based on oxide compounds independently selected from, but not limited to, silica, titania, zirconia, alumina, hafnia, yttria, or independently based on various carbides, nitrides or any combination of the preceding. The organic phase may be based on compounds such as, but not limited to, urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, a member of the polyether family of materials, or combinations of the foregoing.

Of course in some embodiments of the invention, the aerogel composite is not a silica/PMA matrix.

Silica/Chitosan Hybrid

In further embodiments, chitosan is blended with silica aerogels and blankets thereof were are prepared. Such blankets are were placed in a envelope and brought to reduced pressures between about 10⁻⁶ torr and about 760 torr or between about 10⁻² torr and about 760 torr. Reduced pressures between about 760 torr and about 1 torr or between about 1 and about 10 torr may also be used. One non-limiting application for this vacuum packed structure is as carrier for single packed red blood cell (PRBC) transport units. As a non-limiting example, the chitosan-silica hybrid aerogel blankets may be vacuum sealed in Mylar® 350SBL300 film using a vacuum sealer available from AmeriVac LLC. Other sealers are commercially available and may be used by the skilled person. In some embodiments, the pressure in the sealing box was as low as 2.5 torr. These vacuum sealed assemblies (VSA) performed as shown in Tables 1, 2 and 3.

Table 1 shows the properties of hybrid chitosan-silica aerogle composites before and after vacuum sealing (*includes Mylar film weight). Table 2 shows the properties of hybrid aerogel composites reinforced with overlaid sheets of polyester (*includes Mylar film). Table 3 shows the properties of vacuum sealed overlaid coupons (chitosan-silica hybrids) where *includes Mylar film.

TABLE 1

| | | | Thermal | | | | |
|---|---|---|---|---|---|---|---|
| | | | Conductivity | | | | |
| | | | at | | Vacuum Sealed Coupons | | |
| Chitosan | Carbon | | Atmospheric | | Sealing | Thermal | Density |
| Doping | Black | Target Density | Pressure | Density | Pressure | Conductivity | VSA* |
| (%) | (%) | (g/cc) | (mW/mK) | (g/cc) | (torr) | (mW/mK) | (g/cc) |
| 4 | 0 | 0.055 | 12.8 | 0.108 | 10.1 | 6.6 | 0.135 |
| 3 | 5 | 0.055 | 12.3 | 0.108 | 4.3 | 5.38 | 0.150 |
| 3 | 5 | 0.055 | 11.4 | 0.110 | 4.3 | 5.0 | 0.132 |

TABLE 2

| No | | | | Vacuum Sealed Coupons | | | |
|---|---|---|---|---|---|---|---|
| Of std. | | Thermal | | Sealing | Thermal | Thickness | Deformation |
| blanket | Thickness | Conductivity | Density | Pressure | Conductivity | VSA* | with vacuum |
| layers | (mm) | (mW/mK) | (g/cc) | (torr) | (mW/mK) | (mm) | sealing (%) |
| 1 | 5.4 | 12.3 | 0.108 | 4.3 | 5.4 | 4.6 | 14.8 |
| 1 | 5.8 | 11.4 | 0.110 | 4.3 | 5.0 | 5.2 | 10.3 |
| 2 | 10.7 | 14.1 | 0.074 | 2.9 | 5.6 | 6.9 | 35.5 |
| 2 | 8.3 | 13.0 | 0.094 | 2.8 | 5.8 | 6.0 | 27.7 |
| 3 | 10.8 | 14.0 | 0.087 | 2.7 | 6.5 | 5.9 | 45.4 |
| 4 | 11.6 | 15.3 | 0.078 | 2.7 | 4.6 | 6.1 | 47.4 |

TABLE 3

| No | | | Thermal | | | | |
|---|---|---|---|---|---|---|---|
| of std. | | | Conductivity at | Vacuum Sealed Coupons | | | |
| blanket | | | Atmospheric | Sealing | Thermal | Thickness | Deformation |
| coupons | Thickness | Density | Pressure | Pressure | Conductivity | VSA* | with vacuum |
| overlaid | (mm) | (g/cc) | (mW/mK) | (torr) | (mW/mK) | (mm) | sealing (%) |
| 2 (×2 layers) | 17.2 | 0.073 | 14.2 | 2.8 | 5.0 | 12.2 | 29.0 |
| 2 (×2 layers) | 15.9 | 0.094 | 13.5 | 2.9 | 4.6 | 13.3 | 16.3 |

Overlaying several sheets of blankets followed by vacuum sealing was used to increase the thickness of the VSA and improve its R-value. Each coupon was cast separately with the sol filling as much as possible the fiber reinforcement, then after processing the coupons were vacuum sealed together, as a pack.

Ormosil Aerogel Blanket Containing Silicon Bonded Linear Polymers

An organically modified silica (“ormosil”) aerogel blanket may be prepared used in the practice of the invention. The ormosil matrix materials are best derived from sol-gel processing, such as that composed of polymers (inorganic, organic, or inorganic/organic hybrid) that define a structure with very small pores (on the order of billionths of a meter). Fibrous materials added prior to the point of polymer gelation reinforce the matrix materials. The fiber reinforcement may be a lofty fibrous structure (batting or web) as described herein, but may also include individual randomly oriented short microfibers, and woven or non-woven fibers. More particularly, fiber reinforcements may be based upon either organic (e.g. thermoplastic polyester, high strength carbon, aramid, high strength oriented polyethylene), low-temperature inorganic (various metal oxide glasses such as E-glass), or refractory (e.g. silica, alumina, aluminum phosphate, aluminosilicate, etc.) fibers.

Ormosil aerogels containing a linear polymer as a reinforcing component within the structure of the aerogel may be used. In some embodiments, the polymer is covalently bonded to the inorganic structures to provide linear polymer reinforcement. A number of different linear polymers may be incorporated into the silica network to improve the mechanical properties of the resulting ormosils. Transparent monoliths more compliant than silica aerogels may be produced and used. The improvement in elasticity of these ormosil materials also improve the flexibility and reduce its dustiness in its fiber-reinforced composite.

An ormosil aerogel composition has a linear polymer covalently bonded at one or both ends to the silica network of the aerogel through a C—Si bond between a carbon atom of the polymer and a silicon atom of the network. The polymer may be covalently bonded at both ends to one silicon containing molecule of the network, and thus be intramolecularly linked, or covalently bonded at the two ends to two separate silicon containing molecules of the network, and thus be intermolecularly linked. The linear polymer chains are trialkoxysilylterminated and may be a member of the polyether family or selected from trialkoxysilylterminated polydimethylsiloxane, polyoxyalkylene, polyureane, polybutadiane, polyoxypropylene, or polyoxylpropylene-copolyoxyethylene. Stated differently, the linked linear polymer may be generated from a trialkoxysilyl terminated polydimethylsiloxane, trialkoxysilyl terminated polyoxyalkylene, trialkoxysilyl terminated polyurethane, trialkoxysilyl terminated polybutadiene, trialkoxysilyl terminated polyoxypropylene, trialkoxysilyl terminated polyoxypropylene-copolyoxyethylene, or trialkoxysilyl terminated members of the polyether family.

Such an aerogel composition may be prepared by reacting a trialkoxysilyl terminated linear polymer with a silica precursor at ambient temperature and conditions. The trialkoxysilyl terminated linear polymer is prepared by a method comprising reacting 3-isocyanatopropyl triethoxylsilane with an amino (NH) terminated linear polymer in a suitable solvent at ambient temperature. Methods of preparing trialkoxysilyl terminated linear polymer, and of preparing trialkoxysilyl terminated linear polymer, are known. Alternatively, a method of co-condensing trialkoxysilyl terminated linear polymer with a silica precursor may be used.

Of course in some embodiments of the invention, the aerogel composite is not an ormosil matrix.

The details of one or more embodiments of the invention are set forth in the accompanying drawings and the additional description below. Other features and advantages of the invention will be apparent from the drawings and detailed description, and from the claims.

### BRIEF DESCRIPTION OF THE DRAWINGS

FIG. 1 is a photograph demonstrating the flexibility of aerogel composite AR3103.

FIG. 2 is a second photograph demonstrating the flexibility of aerogel composite AR3103.

FIG. 3 is a photograph demonstrating the flexibility of aerogel composite AR5103.

FIG. 4 is a second photograph demonstrating the flexibility of aerogel composite AR5103.

FIG. 5 shows a sample vacuum insulated panel (VIP) of the invention and a bi-planar folded VIP.

FIG. 6 shows a bi-planar folded VIP from a different perspective and with a measurement reference.

FIG. 7 shows a plot of the thermal conductivity vs temperature (at 760 torr) for aerogel composite AR3103.

FIG. 8 shows a plot of the thermal conductivity vs pressure (at 38° C., upper line, and −130° C., lower line) for AR3103.

FIG. 9 shows a plot of the thermal conductivity vs temperature (at 760 torr) for aerogel composite AR5103.

FIG. 10 shows a plot of the thermal conductivity vs pressure (at 20° C., upper line, and −122° C., lower line) for AR5103.

FIG. 11, parts A-D, illustrate sample “patterns” for aerogel VIB core material.

FIG. 12 is a schematic of a cross-section of a VIB embodiment.

FIG. 13 is an expanded view of a portion of FIG. 12.

FIG. 14 illustrates a sample bagging approach for the manufacture of an aerogel-based VIB.

FIG. 15 shows a schematic design of a pouch embodiment of the invention.

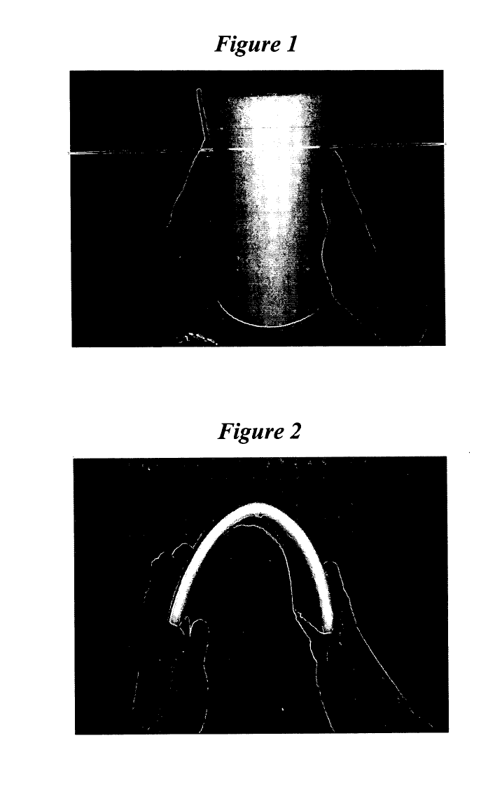

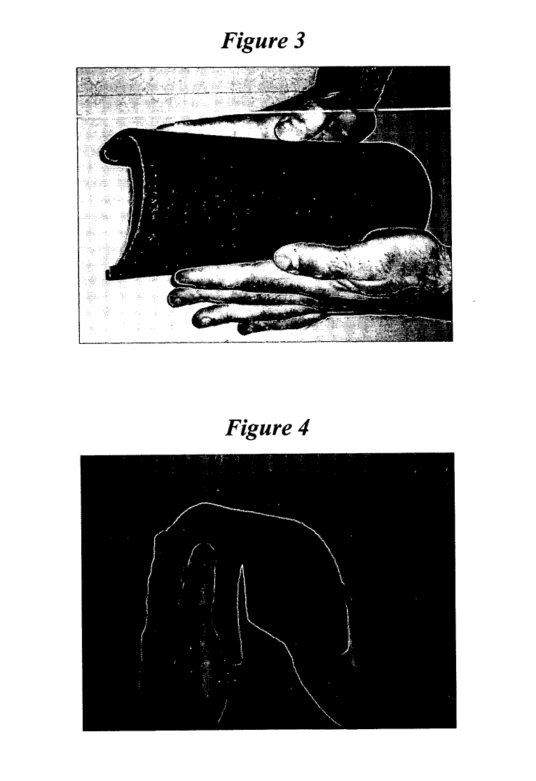

Having now generally described the invention, the same will be more readily understood through reference to the following examples which are provided by way of illustration, and are not intended to be limiting of the present invention, unless specified.

### EXAMPLES

### Example 1

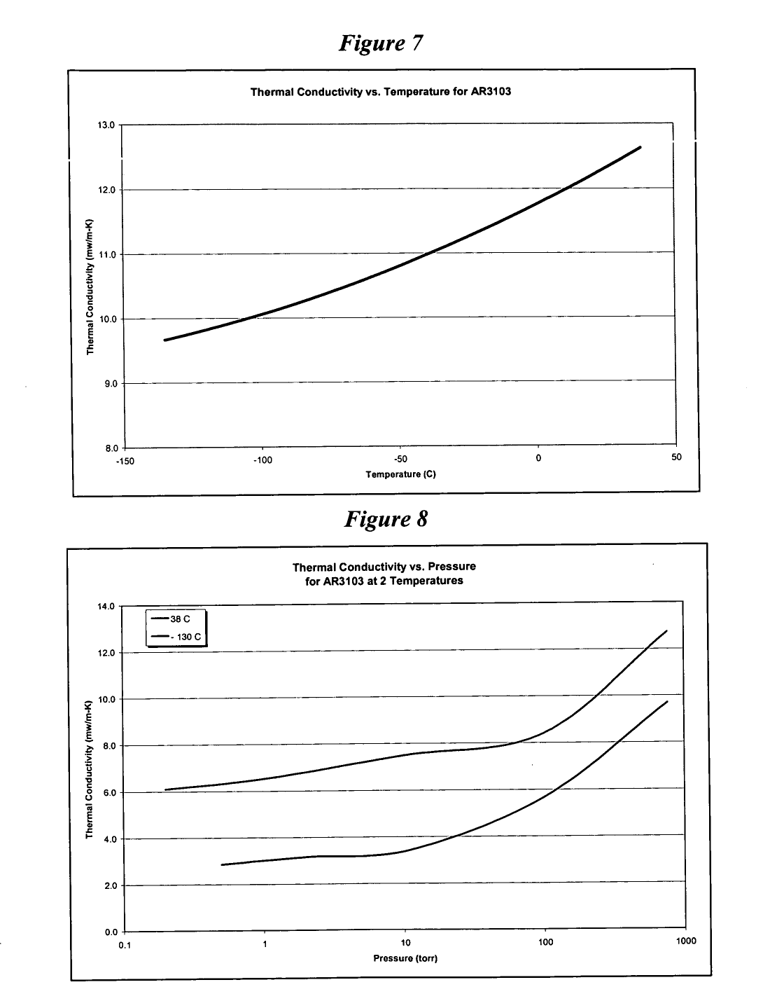

A vacuum-sealed structure comprising an aerogel composite is prepared, said aerogel composite being ¼ inch thick and comprising a silica aerogel matrix reinforced with a polyester batting. The composite is referred to as AR3103. The thermal conductivity of such composite aerogels at various pressures and temperatures are displayed in FIGS. 7 and 8.

### Example 2

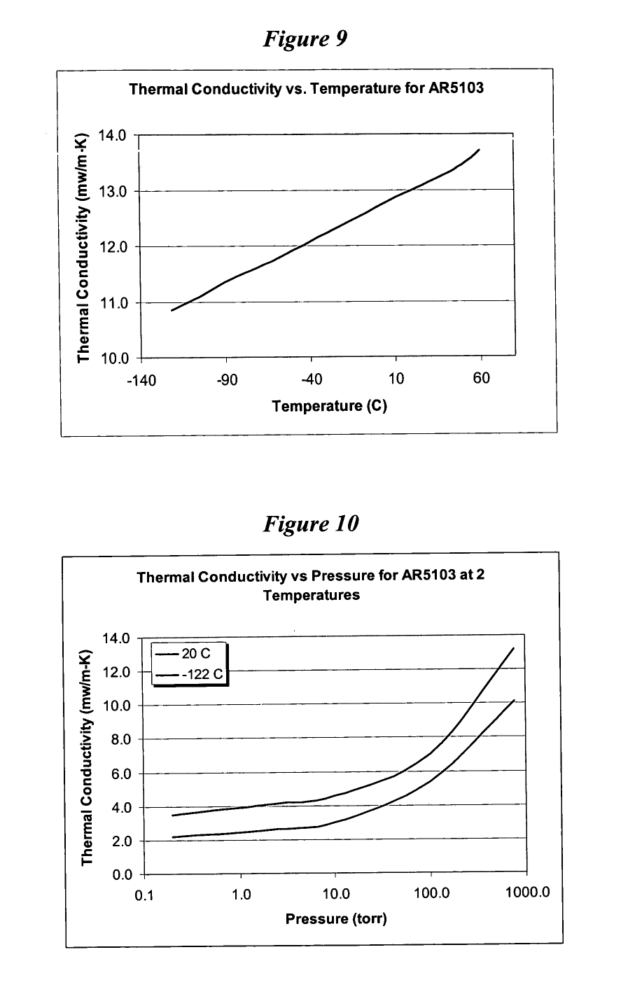

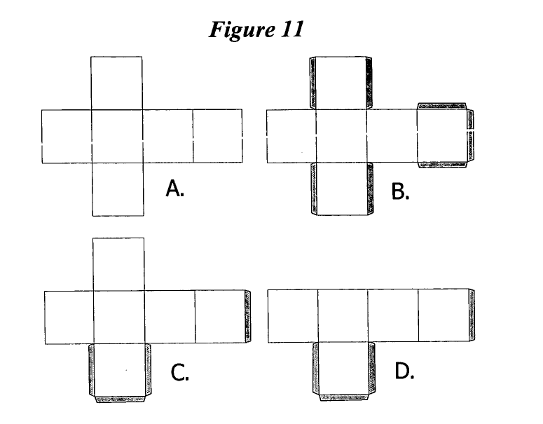

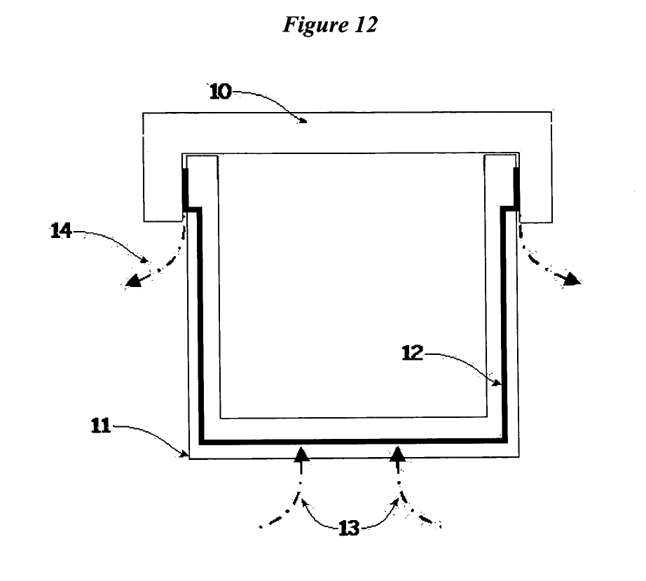

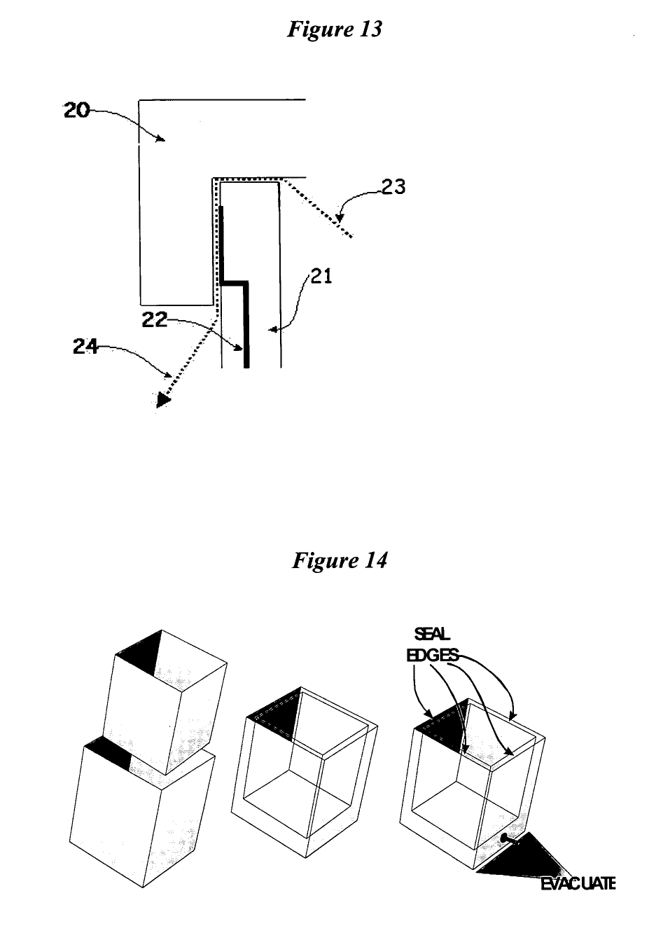

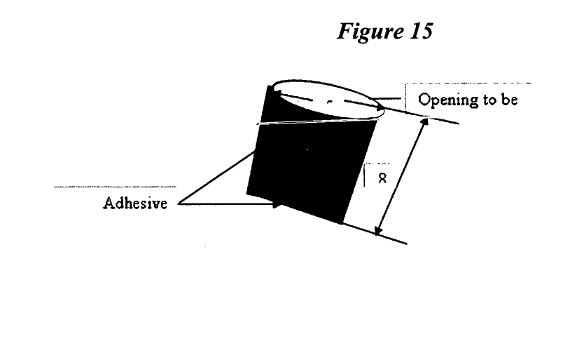

A vacuum-sealed structure comprising an aerogel composite is prepared, said aerogel composite being ¼ inch thick and comprising a silica aerogel matrix reinforced with a polyester batting and opacified with carbon black, The composite is referred to as AR5103. The thermal conductivity of such composite aerogels at various pressures and temperatures are displayed in FIGS. 9 and 10.

### Example 3

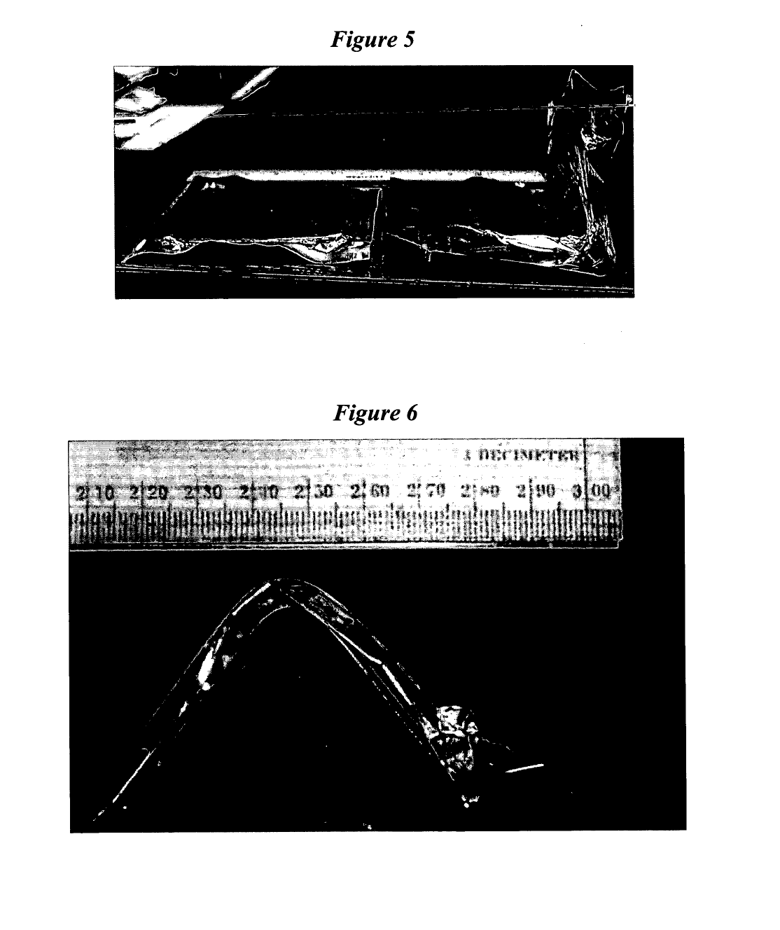

A PMA/Silica hybrid aerogel blanket was prepared with a target density of 0.10 g/cc and a polymer content of 50% wt. The compression deformation under 17.5 psi load was about 12.7% on average and about 11.7% at a minimum. The thermal conductivity was about 17.8 mW/mK on average. The actual density was about 0.16 g/cc. Such blankets, displayed a thermal conductivity of 4.8 mW/mK at a mean temperature of 70° F. with a (hot-cold) temperature range of 40° F. The structure was able to conform to at least a 90° bend with a radius of curvature of less than about ½ inch or about ¼ inch or about ⅛ inch. This sealed insulating structure prior to evacuation, can be bent or otherwise physically manipulated to a desired shape followed by application of a vacuum and a sealing step thereby creating the vacuum sealed molded structure as exemplified by FIG. 5. FIG. 6 further illustrates constant cross section of such structures when bent to about 90° or less and while showing a radius of curvature of less than ½ inch.

Alternatively, the same PMA/Silica hybrid aerogel blanket is prepared but with a target density of about 0.10 g/cc and a polymer loading of about 20%.

All references cited herein are hereby incorporated by reference in their entireties, whether previously specifically incorporated or not. As used herein, the terms “a”, “an”, and “any” are each intended to include both the singular and plural forms.

Having now fully described this invention, it will be appreciated by those skilled in the art that the same can be performed within a wide range of equivalent parameters, concentrations, and conditions without departing from the spirit and scope of the invention and without undue experimentation. While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. A structure comprising a flexible aerogel composite fully enclosed by an envelope and sealed at a reduced pressure.

2. The structure of claim 1 wherein said aerogel composite comprises at least one metal oxide matrix and a fibrous material incorporated therein,
optionally wherein said composite, and optionally said structure, is capable of bending to at least 90° with a bending radius of less than ½ inch.

3. The structure of claim 1 wherein the aerogel composite comprises at least one organic polymer; or
wherein an amount of at least one opacifying compound is incorporated in the aerogel composite.

4. The structure of claim 3 wherein said organic polymer is chitosan, polymethyl methacrylate, a member of the acrylate family of oligomers, trialkoxysilylterminated polydimethylsiloxane, polyoxyalkylene, polyurethane, polybutadiene, a member of the polyether family of materials or combinations thereof.

5. The structure of claim 2 wherein the metal oxide is silica, titania, zirconia, alumina, hafnia, yttria, ceria or combinations thereof; or
wherein the aerogel composite comprises nitrides, carbides or any combination thereof; or
wherein the fibrous material is in the form of a fibrous batting, a lofty batting, microfibers or a felt; or
wherein the fibrous material is based on polyester, silica, carbon or a combination thereof; or
wherein said fibrous material is coated with a polymeric or metallic compound.

6. The structure of claim 3 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

7. The structure of claim 1 wherein at least two plies of an aerogel composite are fully enclosed within the envelope; or
further comprising at least one layer of fibrous material, within the envelope; or
wherein the aerogel composite has a density between about 0.01 g/cc to about 0.40 g/cc or between about 0.07 g/cc to about 0.03 g/cc; or
wherein the thermal conductivity of the aerogel composite within said structure at pressures between about 760 torr and about 0.2 torr and between temperatures of about 20° C. and about −122° C. is between about 2.2 mW/mK and about 13.2 mW/mK; or
wherein the thermal conductivity of the aerogel composite within said structure at pressures between about 760 torr and about 0.2 torr and between temperatures of about 38° C. and about −130° C. is between about 2.85 mW/mK and about 12.7 mW/mK; or
wherein the flexural strength of the aerogel composite is at least about 100 psi at rupture; or
wherein the envelope is a polymeric, optionally metallized, film; or
wherein the envelope is a mylar film.

8. The structure of claim 1 wherein said structure is in the shape of a box; or
wherein said structure is partially or completely bent around a pipeline; or
wherein the structure is in the shape of a panel.

9. A method of preparing a structure comprising fully enclosing a flexible aerogel composite an envelope and sealing said aerogel composite at a reduced pressure.

10. The method of claim 9 wherein said aerogel composite comprises at least one metal oxide matrix and a fibrous material incorporated therein, optionally wherein said structure can bend to at least 90° with a bending radius of less than ½ inch.

11. The method of claim 9 wherein the aerogel composite comprises at least one organic polymer; or
wherein an amount of at least one opacifying compound is incorporated in the aerogel composite.

12. The method of claim 11 wherein said organic polymer is chitosan, polymethyl methacrylate, a member of the acrylate family of oligomers, trialkoxysilylterminated polydimethylsiloxane, polyoxyalkylene, polyurethane, polybutadiene, a member of the polyether family of materials or combinations thereof.

13. The method of claim 10 wherein the metal oxide is silica, titania, zirconia, alumina, hafnia, yttria, ceria or combinations thereof; or
wherein the aerogel composite comprises nitrides, carbides or any combination thereof; or
wherein the fibrous material is in the form of a fibrous batting, a lofty batting, microfibers or a felt; or
wherein the fibrous material is based on polyester, silica, carbon or a combination thereof; or
wherein said fibrous material is coated with a polymeric or metallic compound.

14. The method of claim 11 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

15. The method of claim 9 wherein at least two plies of an aerogel composite are fully enclosed within the envelope; or
further comprising at least one layer of fibrous material, within the envelope; or
wherein the aerogel composite has a density between about 0.01 g/cc to about 0.40 g/cc or between about 0.07 g/cc to about 0.30 g/cc; or
wherein the thermal conductivity of the aerogel composite within said structure at pressures between about 760 torr and about 0.2 torr and between temperatures of about 20° C. and about −122° C. is between about 2.2 mW/mK and about 13.2 mW/mK; or
wherein the thermal conductivity of the aerogel composite within said structure at pressures between about 760 torr and about 0.2 torr and between temperatures of about 38° C. and about −130° C. is between about 2.85 mW/mK and about 12.7 mW/mK; or
wherein the flexural strength of the aerogel composite is 102 psi at rupture; or
wherein the envelope is a polymeric, optionally metallized, film; or
wherein the envelope is a mylar film.

16. The method of claim 9 wherein said structure is in the shape of a box; or
wherein said structure is partially or completely bent around a pipeline; or
wherein the structure is in the shape of a panel.

17. A structure comprising a flexible aerogel composite and a reinforcing component,
wherein said composite, or said composite and component, is fully enclosed by an envelope and sealed at reduced pressure.

18. The structure of claim 17 wherein said reinforcing component is stainless steel, elemental metals such as copper or iron, and other metallic, semi-metallic and alloyed materials; or
wherein said reinforcing component is in the form of a mesh, a screen, or chicken-wire; or
wherein said reinforcing component is integrated into said composite; or
wherein said reinforcing component is fully enclosed and sealed at reduced pressure.

19. A method of preparing a structure according to claim 17, said method comprising fully enclosing said composite and/or reinforcing component in an envelope and sealing at reduced pressure.

20. A pipe or pipeline, optionally for transporting liquefied natural gas, wrapped by the structure of any one of claims 17.
